(19) United States
(12) Patent Application Publication
(10) Pub. No.: US 2024/0387928 A1
(43) Pub. Date: Nov. 21, 2024

(54) BATTERY CASING FOR A VEHICLE

(71) Applicants: HYUNDAI MOTOR COMPANY, Seoul (KR); KIA CORPORATION, Seoul (KR); HYUNDAI STEEL COMPANY, Incheon (KR)

(72) Inventors: Sung Ho Yoon, Seoul (KR); Uk Heo, Incheon (KR)

(73) Assignees: HYUNDAI MOTOR COMPANY, Seoul (KR); KIA CORPORATION, Seoul (KR); HYUNDAI STEEL COMPANY, Incheon (KR)

(21) Appl. No.: 18/514,852

(22) Filed: Nov. 20, 2023

(30) Foreign Application Priority Data
May 19, 2023 (KR) 10-2023-0064826

(51) Int. Cl. H01M 50/249; H01M 50/242

(52) U.S. Cl. CPC H01M 50/249; H01M 50/242; H01M 2220/20

(57) ABSTRACT

Disclosed is a battery casing for a vehicle. The battery casing includes a housing having a lateral surface portion, a first reinforcement part coupled to the lateral surface portion to define a closed cross-section, a second reinforcement part coupled to the first reinforcement part, and a side panel configured to integrally surround the second reinforcement part.

### CROSS-REFERENCE TO RELATED APPLICATION

The present application claims priority to and the benefit of Korean Patent Application No. 10-2023-0064826 filed on May 19, 2023, the entire contents of which are incorporated herein by reference.

### BACKGROUND

### Field of the Disclosure

The present disclosure relates to a battery casing mounted in a vehicle.

### Description of the Related Art

A battery casing for a vehicle refers to a device that accommodates a battery module used for the vehicle and protects a battery from an external environment and a collision. In general, a capacity of a battery for an electric vehicle with a traveling distance of 400 km or more is 60 kWh or more. In this case, a protection device for protecting the battery module adopts a structure in which five to seven steel panels are stacked.

However, because of the battery casing's simple structure, e.g., a structure formed with plates and angular pipes, there is still a concern that the such structure is heavy and may lack the strength needed to effectively protect the battery module from impact or a compressive load.

In other words, the simple structure of the battery casing made of a steel material is easily subjected to buckling deformation when a broadside collision occurs and an external force is applied, The structure of the battery casing cannot contribute to a reduction in weight.

The foregoing explained as the background is intended merely to aid in the understanding of the background of the present disclosure, and is not intended to mean that the present disclosure falls within the purview of the related art that is already known to those skilled in the art.

### SUMMARY OF THE DISCLOSURE

The present disclosure has been made keeping in mind the above problems occurring in the related art. In particular, the present disclosure provides a vehicle battery casing with reduced weight as compared to a vehicle casing in the related art such that a battery capacity for each weight may increase. Despite the weight reduction, the battery casing exhibits enhanced mechanical rigidity, providing the effective performance of its battery protection function.

According to one aspect of the present disclosure, a battery casing for a vehicle includes: a housing having an internal space for accommodating a battery and having a lateral surface portion configured to cover a lateral surface of the battery. The battery casing further includes a first reinforcement part shaped to extend in a longitudinal direction along the lateral surface portion of the housing and coupled to the lateral surface portion to define a closed cross-section. The battery casing further includes a second reinforcement part shaped to extend in the longitudinal direction along the lateral surface portion of the housing and coupled to the first reinforcement part. The battery casing further includes a side panel shaped to extend in the longitudinal direction along the lateral surface portion of the housing and having an end coupled to the first reinforcement part to integrally surround the second reinforcement part.

In one embodiment, the first reinforcement part may be repeatedly bent in a width direction of the lateral surface portion of the housing and a direction perpendicular to a ground surface and thus the first reinforcement part is configured to define: a concave-convex structure including a recessed portion recessed in the width direction of the housing, and a protruding portion protruding in the width direction of the housing.

In one embodiment, the second reinforcement part may be coupled to the recessed portion.

In one embodiment, an end of the side panel coupled to the first reinforcement part may be bent in the direction perpendicular to the ground surface and coupled to be in surface contact with the protruding portion of the first reinforcement part.

In one embodiment, a lower portion of the side panel and a lower portion of the second reinforcement part may each have a shape having an increasing gradient as they (i.e., the lower portion of the side panel and the lower portion of the second reinforcement part) extend from the lateral surface portion of the housing.

The lower portion of the side panel and the lower portion of the second reinforcement part may be shaped to have the same gradient.

In one embodiment, the lower portion of the side panel and the lower portion of the second reinforcement part may be shaped to have a gradient in a range of 1 to 10 degrees.

In one embodiment, through-holes may be formed at one end of the side panel and one end of the second reinforcement part, and reinforcement members may be coupled to the through-holes.

In one embodiment, the second reinforcement part may be made of different types of materials from the lateral surface portion, the first reinforcement part, and the side panel.

In one embodiment, tensile strength of the lateral surface portion, the first reinforcement part, and the side panel may be equal to or greater than 1,200 MegaPascal (MPa).

In one embodiment, the second reinforcement part may include first and second bent portions shaped to protrude and spaced apart from each other in the longitudinal direction. In particular, the first bent portion may be inclined at one point in a width direction such that two opposite ends extending in the width direction have different heights, and two opposite ends of the second bent portion extending in the width direction may have the same height.

The second reinforcement part may further include a third bent portion having a shape bent downward between the first and second bent portions or between the second bent portions.

According to the battery casing of the present disclosure, the aluminum board may be also used, which may reduce costs required to manufacture the battery casing. Some components for protecting the lateral surface portion of the battery casing are integrated, which may also reduce the weight. Thus, the mechanical rigidity such as compressive strength is improved even though the weight is reduced, such that the function of effectively protecting the lateral surface of the battery casing may be secured.

### BRIEF DESCRIPTION OF THE DRAWINGS

In order that the disclosure may be well understood, there are now described various forms thereof, given by way of example, reference being made to the accompanying drawings, in which:

FIG. 1 is a perspective view of a battery casing for a vehicle in an embodiment of the present disclosure;

FIG. 2 is a view illustrating a lateral part of a battery casing for a vehicle according to an embodiment of the present disclosure;

FIG. 3 is an exploded view of the lateral part of the battery casing for a vehicle according to the embodiment of the present disclosure;

FIG. 4 is a view illustrating states of a cross-section of the lateral part of the battery casing before and after a collision of the lateral part according to the embodiment of the present disclosure;

FIG. 5 is a perspective view of a second reinforcement part according to an embodiment of the present disclosure;

FIG. 6 is a cross-sectional view taken along line A-A′ in FIG. 2;

FIG. 7 is a cross-sectional view taken along line B-B′ in FIG. 2;

FIG. 8 is a cross-sectional view taken along line C-C′ in FIG. 2; and

FIG. 9 is a cross-sectional view taken along line D-D′ in FIG. 2.

### DETAILED DESCRIPTION

Hereinafter, embodiments disclosed in the present specification are described in detail with reference to the accompanying drawings. The same or similar constituent elements are assigned with the same reference numerals regardless of reference numerals, and the repetitive description thereof has been omitted.

In the description of the embodiments disclosed in the present specification, the specific descriptions of publicly known related technologies have been omitted when it is determined that the specific descriptions may obscure the subject matter of the embodiments disclosed in the present specification. In addition, it should be interpreted that the accompanying drawings are provided only to allow those having ordinary skill in the art to easily understand the embodiments disclosed in the present specification, and the technical spirit disclosed in the present specification is not limited by the accompanying drawings, and rather includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description, but the suffixes themselves do not have distinguishable meanings or functions.

When a component, device, element, or the like of the present disclosure is described as having a purpose or performing an operation, function, or the like, the component, device, or element should be considered herein as being “configured to” meet that purpose or to perform that operation or function.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

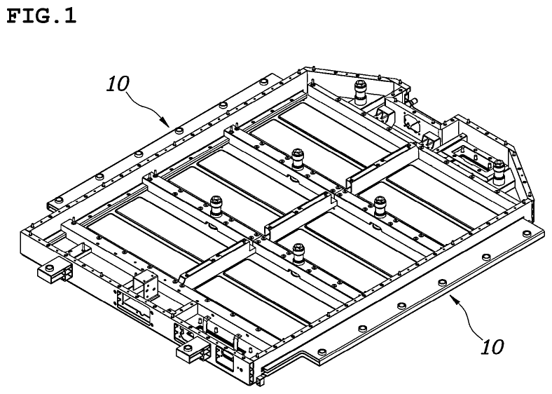

FIG. 1 is a perspective view of a battery casing for a vehicle in an embodiment of the present disclosure.

In general, a battery, which is an energy source for a vehicle, is accommodated in a battery casing for a vehicle and mounted at a lower side of the vehicle. A secondary lithium battery is mainly used as the battery, and the secondary lithium battery includes therein a flammable electrolyte or the like.

Meanwhile, an external impact may be applied to the secondary lithium battery in the event of a vehicle collision, which may cause an internal short circuit in the secondary lithium battery. The internal short circuit causes a side reaction in the secondary lithium battery, and a safety accident such as explosion may be caused by thermal runaway of the secondary lithium battery.

In particular, the battery casing is mounted at the lower side of the vehicle such that the battery and the lateral frame of the vehicle are positioned to be close to each other. Therefore, it is desired to suppress the occurrence of the internal short circuit by preventing an internal structure on a lateral surface of the battery casing from penetrating the battery in the event of a broadside collision between the vehicles. To this end, a lateral part 10 of the battery casing for a vehicle is generally designed to withstand a load generated in the event of a broadside collision of the vehicle.

However, various components are assembled during a process of increasing mechanical rigidity of the lateral part 10, which causes an unnecessary increase in weight of the battery casing, degrades energy efficiency, and requires a large amount of costs to manufacture the battery casing.

In one embodiment of the present disclosure, the battery casing for a vehicle includes a housing 100 having an internal space for accommodating a battery and having a lateral surface portion 150 configured to cover a lateral surface of the battery. The battery casing further includes: a first reinforcement part 200 shaped to extend in a longitudinal direction along the lateral surface portion 150 of the housing 100 and coupled to the lateral surface portion 150 to define a closed cross-section; and a second reinforcement part 300 shaped to extend in the longitudinal direction along the lateral surface portion 150 of the housing 100 and coupled to the first reinforcement part 200. The battery casing further includes a side panel 400 shaped to extend in the longitudinal direction along the lateral surface portion 150 of the housing 100 and having an end coupled to the first reinforcement part 200 to integrally surround the second reinforcement part 300.

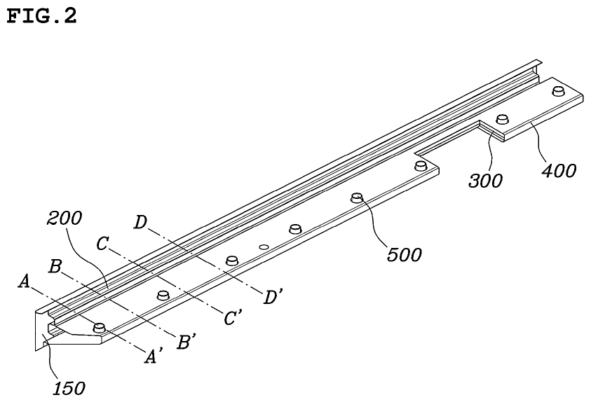

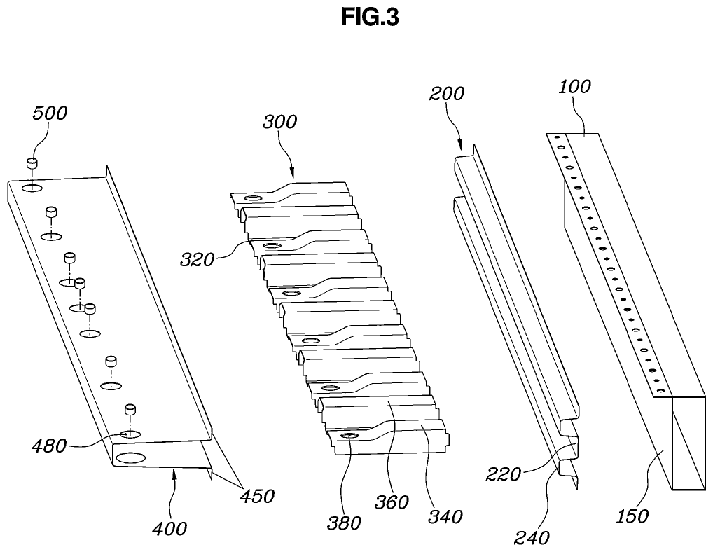

FIG. 2 is a view illustrating the lateral part of the battery casing for a vehicle according to an embodiment of the present disclosure, and FIG. 3 is an exploded view of the lateral part of the battery casing for a vehicle according to an embodiment of the present disclosure.

With reference to FIGS. 2 and 3, the first reinforcement part 200, the second reinforcement part 300, and the side panel 400 are coupled along the lateral surface portion 150 of the housing and constitute the lateral part 10 of the battery casing. Specifically, the first reinforcement part 200 is coupled to the lateral surface portion 150 of the housing 100, and the second reinforcement part 300 is coupled to the first reinforcement part 200. The side panel 400 is coupled to the first reinforcement part 200 while integrally surrounding the second reinforcement part 300.

The first reinforcement part 200 is coupled to the lateral surface portion 150 and defines a closed cross-section. The formed closed cross-section prevents a battery casing structure from entering the internal space in which the battery is loaded in the event of a broadside collision of the vehicle.

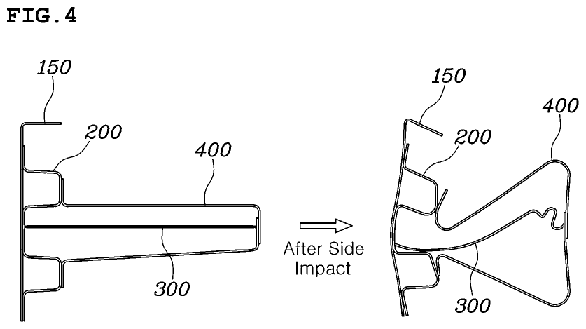

In other words, with reference to FIG. 4, the closed cross-section may be defined by coupling the lateral surface portion 150 and the first reinforcement part 200 and reinforce bending rigidity. Therefore, it is possible to protect the battery by preventing the structure from entering the internal space of the battery casing even in the event of a broadside collision.

Meanwhile, because of the broadside collision, an upper portion of the side panel 400 is deformed upward, a lower portion of the side panel 400 is deformed downward, and the second reinforcement part 300 is deformed upward and downward. Therefore, the balanced deformation may be induced without upward and downward buckling, thereby allowing the lateral part 10 of the battery casing to effectively absorb collision energy.

In particular, according to a result of performing a compression test on the battery casing for a vehicle according to various embodiments of the present disclosure, a compressive reaction force (compressive strength maximum load) was 210.7 kilonewton (kN) to 250.2 kN.

In the experiment, the battery casing, in which a thickness of the side panel was 1.0t, a thickness of the second reinforcement part was 0.8t to 2.0t, and the second reinforcement part was made of steel or aluminum, was used. A density of the used steel was 7.85E-6 kg/mm³, an elastic modulus was 200 GPa, a density of the used aluminum was 2.9E-6 kg/mm³, and an elastic modulus was 71 Gpa. The result is summarized in Table 1 below.

TABLE 1

| | | Thickness | | |
|---|---|---|---|---|
| | | and material | | Compressive |
| | | of second | | strength |
| | Thickness of | reinforcement | Weight | maximum load |
| | side panel | part | (kg) | (kN) |
| Comparative | 1.0t | 0.8t (Steel) | 6.61 | 210.7 |
| Example 1 | | | | |
| Comparative | 1.0t | 1.0t (Steel) | 6.89 | 234.7 |
| Example 2 | | | | |
| Example 1 | 1.0t | 1.6t | 6.25 | 232.1 |
| | | (Aluminum) | | |
| Example 2 | 1.0t | 1.8t | 6.35 | 246.2 |
| | | (Aluminum) | | |
| Example 3 | 1.0t | 2.0t | 6.45 | 250.2 |
| | | (Aluminum) | | |

According to the above-mentioned result, it can be seen that the lateral part of the battery casing according to the present disclosure has a weight of about 6 kg and thus is lightweight and excellent in compressive strength maximum load.

In particular, in comparison with a case in which steel is used as in Comparative Examples 1 and 2, the weight with respect to the thickness is light, and the compressive strength maximum load tends to increase in a case in which aluminum is used as in Examples 1 to 3. Therefore, a material of the second reinforcement part 300 may be aluminum.

In addition, because the price of aluminum is lower than the price of steel, the use of aluminum is preferable in terms of a reduction in costs.

In one embodiment, the remaining components may be made of steel, and tensile strength of the lateral surface portion 150, the first reinforcement part 200, and the side panel 400 may be equal to or greater than 1,200 MPa.

Meanwhile, a coupling relationship of the lateral part of the battery casing for a vehicle according to the embodiment of the present disclosure is specifically described below.

With reference to FIG. 3, the first reinforcement part 200 is coupled to the lateral surface portion 150 of the battery housing. The first reinforcement part 200 is repeatedly bent in a width direction of the lateral surface portion 150 of the housing and a direction perpendicular to the ground surface, thereby defining a concave-convex structure. The concave-convex structure includes: a recessed portion 220 recessed in the width direction of the housing 100, and protruding portions 240 that protrud in the width direction of the housing.

A closed cross-section may be formed between the first reinforcement part 200 and the lateral surface portion 150 by the concave-convex structure. The formed closed cross-section may prevent the battery structure from penetrating the interior of the battery casing in the event of a broadside collision.

Meanwhile, the second reinforcement part 300 may be coupled to the recessed portion 220 of the first reinforcement part 200 to reinforce the mechanical rigidity of the battery casing. One end of the second reinforcement part 300 may be fastened along the recessed portion 220 of the first reinforcement part 200 extending in the longitudinal direction of the housing 100, thereby defining a closed cross-section together with the side panel 400 to be described below.

As described above, the second reinforcement part 300 may be made of aluminum.

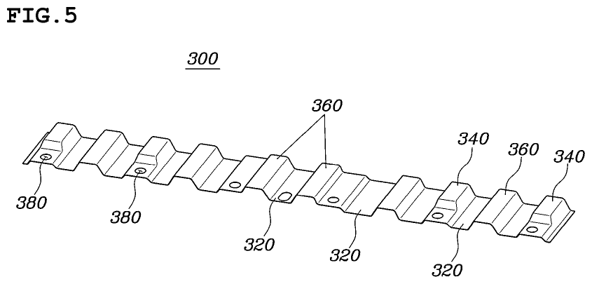

Meanwhile, with reference to FIGS. 3 and 5, the second reinforcement part 300 has a shape being bent upward and downward along the width direction and also being bent in the longitudinal direction of the housing 100. In one embodiment, the second reinforcement part 300 includes first and second bent portions 340 and 360 spaced apart from one another.

Specifically, two opposite ends of the first bent portion 340 based on the width direction may be shaped to have different heights, and two opposite ends of the second bent portion 360 based on the width direction may be shaped to have the same height. The second reinforcement part 300 may further include third bent portions 320 recessed and bent downward between the first bent portion 340 and the second bent portion 360 or between the second bent portions 360.

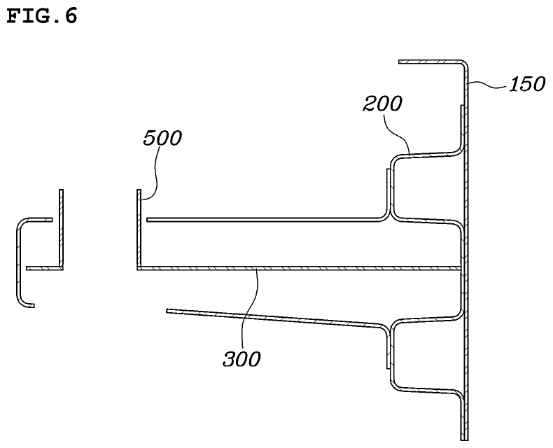

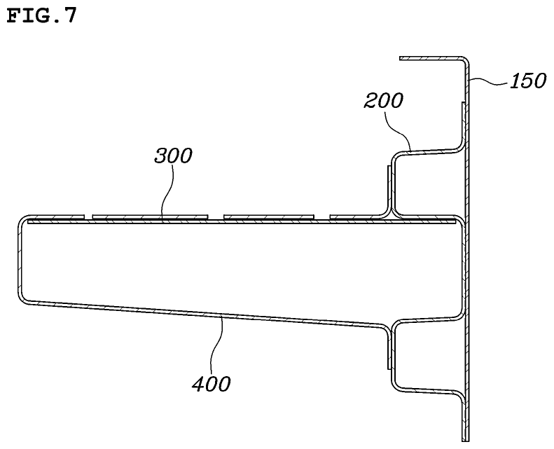

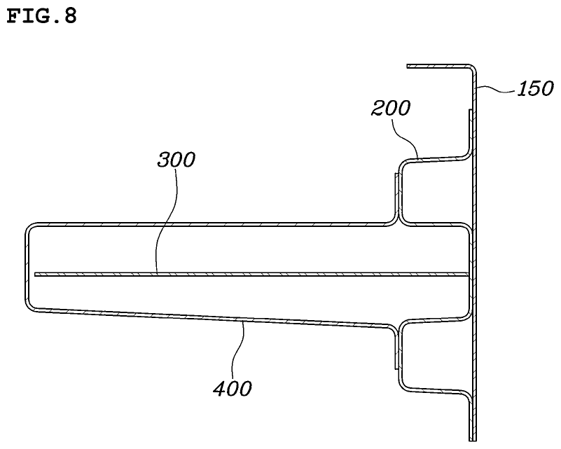

As described above, in case that the second reinforcement part 300 includes the shapes having various heights, the closed cross-sections with various shapes may be defined between the side panel 400 and the second reinforcement part 300 by coupling with the side panel 400, as illustrated in FIGS. 6 to 9. Therefore, the collision energy may be efficiently dispersed, and an area of a portion where the second reinforcement part 300 and the first reinforcement part 200 are in contact with each other may be maximized, thereby improving the structural rigidity.

Meanwhile, the side panel 400 is coupled to the protruding portion 240 of the first reinforcement part 200. Specifically, ends of the side panel 400 are bent in the direction perpendicular to the ground surface to define contact portions 450 being in surface contact with the protruding portions 240 of the first reinforcement part 200. The contact portions 450 of the side panel 400 and the protruding portions 240 of the first reinforcement part 200 are coupled, such that the side panel 400 may be coupled to the first reinforcement part 200.

The side panel 400 may be coupled to the first reinforcement part 200 and integrally surround the second reinforcement part 300.

Meanwhile, the lower portion of the side panel 400 and the lower portion of the second reinforcement part 300 may each have a shape having a gradient that increases as the lower portion of the side panel 400 and the lower portion of the second reinforcement part 300 extend from the lateral surface portion 150 of the housing.

With reference to FIGS. 2, 3, and 5 to 9, the lower portion of the side panel 400 has a shape having a gradient that increases as the distance from the lateral surface portion 150 of the housing increases. Therefore, the gradient allows the side panel 400 to support the other components and effectively absorb impact while being constantly deformed while being maximally kept in an original state so that the side panel 400 is not bent upward or downward even though a load is applied from a lateral side.

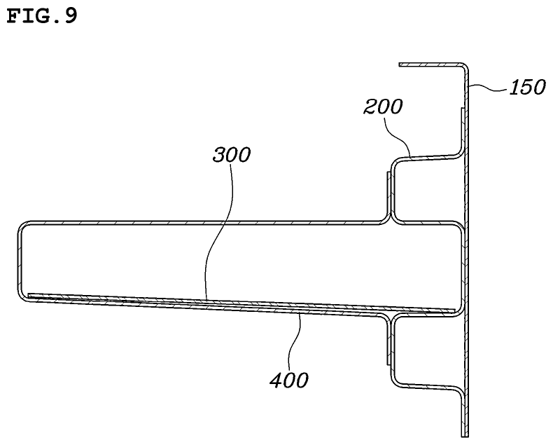

With reference to FIG. 9, it can be ascertained that the lower portion of the second reinforcement part 300 is formed in a shape having a gradient that increases as the distance from the lateral surface portion 150 increases, and the lower portion of the second reinforcement part 300 has the same gradient as the lower portion of the side panel 400.

The lower portion of the second reinforcement part 300 may be a portion being in contact with the lower portion of the side panel 400, and the lower portion of the side panel 400 and the lower portion of the second reinforcement part 300 may each have a gradient of 1 to 10 degrees.

Meanwhile, through-holes 480 and 380 may be formed at one end of the side panel 400 and one end of the second reinforcement part 300, and reinforcement members 500 may be coupled to the through-holes 480 and 380. The reinforcement member 500 may have a hollow portion, and a fastening member penetrates the formed hollow portion, such that the battery casing may be mounted on the vehicle.

In addition, with reference to FIGS. 2, 3, and 5, the through-holes 480 and 380 may be formed in the lower and upper portions of the side panel 400 and one end of the second reinforcement part 300, and the reinforcement members may be inserted into the through-holes 480 and 380 and coupled by welding. The side panel 400 and the second reinforcement part 300 may be supported by coupling the reinforcement members 500, thereby further improving the mechanical rigidity of the lateral part 10 of the battery casing.

While the specific embodiments of the present disclosure have been illustrated and described, it should be obvious to those having ordinary skill in the art that the present disclosure may be variously modified and changed without departing from the technical spirit of the present disclosure.

What is claimed is:

1. A battery casing for a vehicle, the battery casing comprising:
a housing having an internal space for accommodating a battery and including a lateral surface portion configured to cover a lateral surface of the battery;
a first reinforcement part configured to extend in a longitudinal direction of the housing and coupled to the lateral surface portion, forming a closed cross-section;
a second reinforcement part configured to extend in the longitudinal direction of the housing and coupled to the first reinforcement part; and
a side panel configured to extend in the longitudinal direction of the housing and having an internal space and an open side directed toward the second reinforcement part, such that the second reinforcement part is fitted to be surrounded through the open side, and upper and lower ends of the open side are coupled to the first reinforcement part to constitute a member in a longitudinal direction of the vehicle in a state in which the second reinforcement part is embedded.

2. The battery casing of claim 1, wherein the first reinforcement part is repeatedly bent in a width direction of the housing and a direction perpendicular to a ground surface and configured to define a concave-convex structure, wherein the concave-convex structure comprises a recessed portion recessed in the width direction of the housing, and a protruding portion protruding in the width direction of the housing.

3. The battery casing of claim 2, wherein the second reinforcement part is coupled to the recessed portion.

4. The battery casing of claim 2, wherein an end of the side panel coupled to the first reinforcement part is bent in the direction perpendicular to the ground surface and coupled to be in surface contact with the protruding portion of the first reinforcement part.

5. The battery casing of claim 1, wherein a lower portion of the side panel and a lower portion of the second reinforcement part each have a shape having a gradient that increases as the lower portion of the side panel and the lower portion of the second reinforcement part extend from the lateral surface portion of the housing.

6. The battery casing of claim 5, wherein the lower portion of the side panel and the lower portion of the second reinforcement part are shaped to have the same gradient.

7. The battery casing of claim 5, wherein the lower portion of the side panel and the lower portion of the second reinforcement part are shaped to have a gradient in a range of 1 to 10 degrees.

8. The battery casing of claim 1, wherein through-holes are formed at one end of the side panel and one end of the second reinforcement part, and reinforcement members are coupled to the through-holes of the side panel and the second reinforcement part.

9. The battery casing of claim 1, wherein the second reinforcement part is made of different materials from the lateral surface portion, the first reinforcement part, and the side panel.

10. The battery casing of claim 1, wherein tensile strength of the lateral surface portion, the first reinforcement part, and the side panel is equal to or greater than 1,200 MPa.

11. The battery casing of claim 1, wherein the second reinforcement part comprises first and second bent portions shaped to protrude and spaced apart from each other in the longitudinal direction, the first bent portion is inclined at one point in a width direction such that two opposite ends extending in the width direction have different heights, and two opposite ends of the second bent portion extending in the width direction have the same height.

12. The battery casing of claim 11, wherein the second reinforcement part further includes a third bent portion having a shape recessed downward between the first and second bent portions or between the second bent portions.
